(19) United States
(12) Patent Application Publication
(10) Pub. No.: US 2007/0092680 A1
(43) Pub. Date: Apr. 26, 2007

(54) Laser writable media substrate, and systems and methods of laser writing

(76) Inventors: Sterling Chaffins, Albany, OR (US); Douglas R. Houck, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,476

(22) Filed: Oct. 26, 2005

(51) Int. Cl. B32B 3/02

(52) U.S. Cl. 428/64.1

(57) ABSTRACT

Color laser writable media substrates and color laser writing compositions, as well as methods of making and using the same are disclosed herein. One exemplary laser writable substrate is coated with a color laser writing composition, the composition including a polymer blended with a photobleachable dye of a first color, and the polymer and dye being selected to enable a laser to visibly alter the dye from the first color to a second color.

### BACKGROUND

The present disclosure relates to color laser writable optical discs, color laser writing formulations and systems, and methods of making and using the color laser writing formulations and systems.

Markers, adhesive labels, printers, thermal wax transfers, and thermal dye transfers have conventionally been used to label optical discs, such as compact discs (CDs) and digital versatile discs (DVDs). The markers can be messy, and in some cases the writing or text can be illegible. Adhesive labels can be sticky and difficult to apply evenly to the disc. Additionally, there is a risk that an adhesive label could delaminate, thereby causing problems with a disc drive or player. Transferring photographs, graphics, or printed text directly onto discs have traditionally required the use of a printer and ink, for example, an inkjet printer or transfers.

Technology has been developed whereby the disc is coated with a special dye composition. Enhanced disc-burning software is used to create laser-etched images and/or text directly on the coated disc itself. Typically, the coating is applied to the opposite side of the disc that encodes the information stored on the disc. An example of such technology is the LightScribe™ technology developed by Hewlett-Packard Development Company, Inc. and described further at www.lightscribe.com.

Laser writing technology is now available on conventional personal computers (PCs), external USB optical DVD writers, labeling software, and a variety of brand name discs, thereby eliminating the need for a separate printer, adhesive label, or marker to label the disc. The light from the laser causes a chemical change in the dye coating on the label side of a disc. The change is a visible point on the disc made where the laser contacts the disc. With laser-enabling software, the laser can deliver closely controlled light energy to multiple points on the disc, for example, as it spins in a disc drive. The result is a high-resolution reproduction of artwork, text, or photos that have been composed in the software application. Laser beams from conventional write laser mechanisms have a beam width of about 0.5 microns. Thus, the resolutions that can be provided by the laser write mechanisms are extremely high.

Improvements can be made to this technology, however. For example, with current technology, the laser creates an image by a leuco dye reaction. Compositions and system can be developed to increase the “writing speed” of the laser, and to improve thermal stability over longer periods of time.

### BRIEF DESCRIPTION OF THE DRAWINGS

The patent or application file contains at least one drawing executed in color. Copies of this patent or patent application publication with color drawing will be provided by the Office upon request and payment of the necessary fee.

Many aspects of this disclosure can be better understood with reference to the following drawings. The components in the drawings are not necessarily to scale. Moreover, in the drawings, like reference numerals designate corresponding parts throughout the several views.

FIG. 1 is a block diagram depicting a device, having an optical disc drive, a writable label optical disc, and a representative writable label object, in accordance with certain exemplary implementations of the disclosed system.

FIG. 2 is an illustrative representation showing a cross-sectional view of an exemplary conventional optical disc.

FIG. 3 is an illustrative representation showing a cross-sectional view of a an exemplary writable label disc.

FIG. 4 is an illustrative representation showing an exemplary label formed on a disclosed writable label disc.

FIG. 5 is a block diagram illustrating an embodiment of a two-tone laser writing process.

FIG. 6 depicts illustrative representations of two-tone laser written images, at (a) 10×magnification and (b) 20×magnification.

### DETAILED DESCRIPTION

Compositions, systems, and methods are disclosed herein that enable an image to be formed on a substrate (e.g., an optical disc or other like object), using an energy source. One exemplary system and method includes using the energy to write to, and thereby visibly alter, at least a portion of the substrate. The portion of the substrate that is altered includes a composition that can be visibly altered by the energy source. The energy source can be, for example, a write laser mechanism, a thermal pen, a light source, a photochemical mechanism, or any source of radiation. The visible alteration caused by the energy source can be, for example but not limited to, a color change on the substrate that relates to visible text, graphics, and/or images.

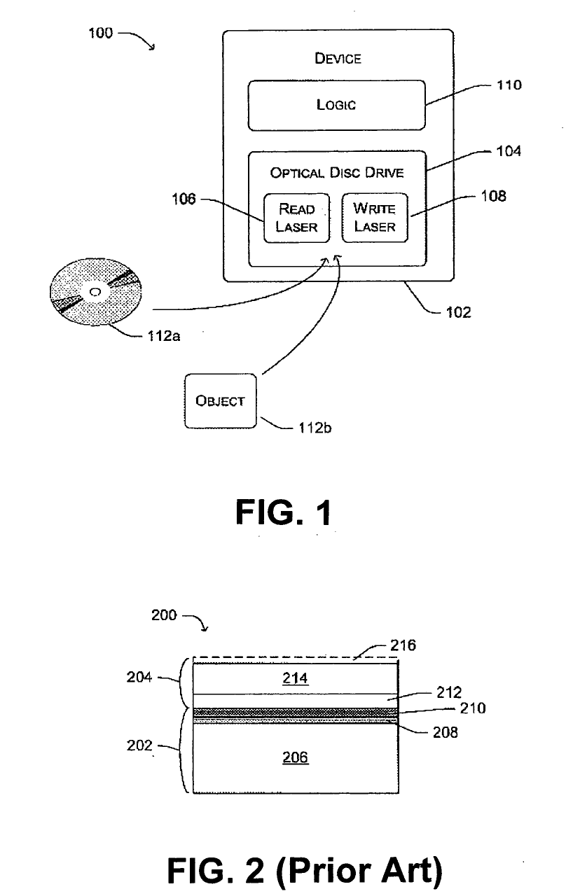

Turning now to the figures for examples of implementations of the disclosed compositions, systems, and methods, FIG. 1 shows a computing environment 100 having a representative device 102. The device 102 includes an optical disc drive 104 having a read laser mechanism 106 and a write laser mechanism 108. The read laser mechanism 106 and the write laser mechanism 108 can include the same or different lasers. The laser can operate at wavelengths of, for example, about 780-790 nanometers, or any other laser capable of effecting writing or formation of images on an optical disc. A light emitting diode (LED) can be used in the disclosed systems in place of a laser. Tables 1 and 2 below list exemplary LED and laser sources, respectively, that can by used in the disclosed systems.

TABLE 1
LED Sources
Wavelength

| Min | Typical | Max |
|---|---|---|
| nm | nm | nm |
| 363 | 367 | 370 |
| 370 | 373 | 375 |
| 370 | 375 | 380 |
| 375 | 378 | 380 |
| | 380 | |
| | 380 | |
| 390 | 395 | 400 |
| | 410 | |
| 440 | 455 | 460 |
| | 460 | |
| 460 | 470 | 490 |
| 470 | 475 | 480 |
| 495 | 505 | 515 |
| 490 | 505 | 520 |
| 520 | 530 | 540 |
| 520 | 530 | 550 |
| 585 | 590 | 595 |
| 612 | 618 | 625 |
| 618 | 626 | 635 |
| | 880 | |
| | 880 | |
| | 940 | |
| | 940 | |
| | White | |

TABLE 2
Laser Sources
Wavelength

| Min | Typical | Max |
|---|---|---|
| nm | nm | Nm |
| 370 | 375 | 380 |
| 400 | 408 | 415 |
| 735 | 440 | 445 |
| 468 | 473 | 478 |
| 650 | 656 | 660 |
| 780 | 784 | 787 |
| 790 | 815 | 840 |
| 970 | 980 | 990 |
| 1520 | 1550 | 1580 |

The optical disc drive 104 is controlled by logic 110. The optical disc drive 104 is configured to receive a writable label disc 112a and/or other suitable writable label object 112b. Here, the logic 110 may include hardware, firmware and/or software that is/are configured to control the optical disc drive 104 such that read laser mechanism 106 can read data from writable label disc 112a, for example, provided of course that data has been written thereto. The logic 110 is further configured to control the writing of data to the writable label disc 112a for storage thereon. The logic 110 is further configured to control the writing of data to the writable label disc 112a to create a visible label thereon, for example, as described in subsequent sections herein.

FIG. 2 shows a cross-sectional view of an exemplary conventional writable compact disc (CD-R) 200. The CD-R disc 200 includes a data storage portion 202 and a protective portion 204. Within data storage portion 202 there is a transparent substrate layer 206, which is typically made of polycarbonate plastic, a dye layer 208, and a reflective layer 210. Within the protective portion 204, there is a lacquer layer 212 and a dye host layer 214. Generally, the dye host layer 214 is capable of hosting of a dye and forming a film. The dye host layer 214 can be, for example, small molecules that can form film such as oligomers, or other polymers.

An attached label 216 may be placed on the dye host layer 214. Data can be stored on the CD-R disc 200 by selectively altering the dye layer 208 using the write laser mechanism 108.

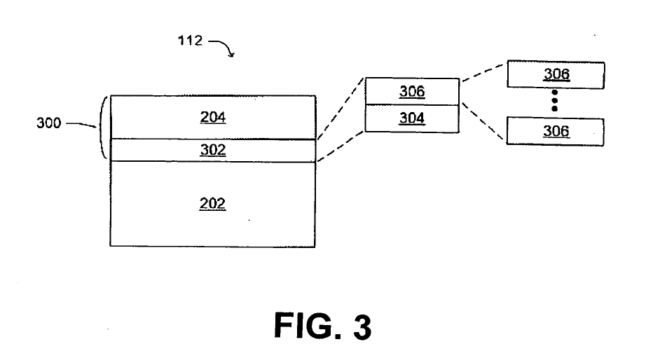

Reference is now made to FIG. 3, which depicts a cross-sectional view of the writable label disc 112, in accordance with certain disclosed exemplary implementations.

The writable label disc 112 includes a data storage portion, such as e.g., the data storage portion 202, and a writable label portion 300. The writable layer portion 300 includes, in this example, at least one writable label layer 302. The writable label disc 112 optionally includes a transparent protective portion, such as, e.g., the protective portion 204.

In accordance with certain disclosed implementations, the writable label layer 302 includes material that can be visibly altered by selectively applying radiative or thermal energy. For example, the material can be altered using the write laser mechanism 108. Thus, the writable label layer 302 can include dye material similar to or different from the dye layer 208. In this manner, portions of the writable layer 302 can be visibly altered to form a label that is visible through the protective portion 204.

In certain implementations, for example, when exposed to an appropriate energy source, the dye material in the writable label layer 302 can be configured to substantially change color, such that, when viewed through the protective portion 204, there is a resulting visible contrast between burned areas and neighboring areas that have not been burned.

The present disclosure further relates to the dye material that can be used in the writable label layer 302 or on any other suitable substrate or material. Generally, the laser writable composition includes a curable (e.g., by UV radiation) host polymer composition blended with a photobleachable dye with a native color. The host and dye are each selected to enable a pre-selected energy source (e.g., a laser) to visibly alter the dye from the first native color to a second “photobleached” color that is visibly different from the native color. In one embodiment, the blended composition has a physical structure that is produced by blending a polymer and the dye in a mill with inturning rollers designed to disperse solids into high viscosity liquids.

The host material of the dye composition can be a thermoset (UV curable) polymer, a thermoplastic (thermally curable) polymer, small molecules (UV or thermally curable), or oligomers (UV or thermally curable). In one embodiment, the host composition is an organic solvent acrylate. The organic solvent acrylate can include, for example, an acrylate oligomer and an acrylate monomer. The organic solvent acrylates can include, for example, any one or combination of methyl methacrylate, hexyl methacrylate, beta-phenoxy ethyl acrylate, hexamethylene acrylate, or combinations thereof.

The host composition can be loaded with various additives such as, for example a photoinitiator or catalyst system. Any photoinitiator can be used so long as the photoinitiator does not absorb light at the same wavelength as the dye during color change. The photoinitiator can be, for example, a hydroxy ketone. One particular host polymer that can be used is CDG0000, a UV-curable ink polymer commercially available from Nor-Cote International of Crawfordsville, Ind.

In addition to the photoinitiator, the host composition can also be loaded with or include other elements such as, for example, a metal, a pigment, a contrast-enhancing additive, and combinations thereof. An example of a contrast-enhancing additive is a metal particle that can reduce glare off the surface of the printed image. Exemplary additives include, but are not limited to, metal oxides (e.g., silica, etc.) and metals (e.g., gold titanium, stainless steel, aluminum, copper, and silver). Varying concentrations of these metal particles are capable of varying degrees of ambient light rejection. The host composition can tolerate a significant amount of material loading without affecting its coloration properties. For example, the polymer composition can be loaded with about 80% silver particles.

The dye that is blended with the polymer can be selected from one or more of, for example, cyanine dyes, merocyanine dyes, complex cyanine dyes, complex merocyanine dyes, holopolar cyanine dyes, styryl dyes, hemicyanine dyes, oxonole dyes, hemioxonol dyes, crystal violet, triarylmethane dyes, diarylmethane dyes, xanthene dyes, thiazine dyes, oxazine dyes, pyrylium dyes, benzopyrylium dyes, trimethinebenzopyrylium dyes, triallylcarbonium dyes, phthalocyanine dyes, porphyrins, and combinations thereof. “Aryl” as used herein refers to aromatic homocyclic (e.g., hydrocarbon) mono-, bi-, or tricyclic ring-containing groups having, for example, 6 to 12 members such as phenyl, naphthyl, and biphenyl.

The host can be blended with the dye, for example, by blending the host in a dye in a mill with inturning rollers, where the mill is designed to disperse solids into liquids, such as that known to one of skill in the art. The amount of dye used to achieve coloration will depend upon the absorptivity of the dye. In addition, the amount of the dye will depend on the background of the material being printed on. For example, a dye that changes a substrate to orange upon exposure to radiation will be used in a different amount on a gold-colored substrate than in a white-colored substrate. Therefore, the amount of dye used can be tailored for a specific application. For example, with cyanine dyes, the dye can be at least about 8% by weight of the polymer/dye composition, or about 10% by weight of the polymer/dye composition.

Also disclosed are methods for laser writing. One such exemplary method includes the steps of, not necessarily in any particular order, blending a curable polymer with a photobleachable dye as disclosed herein, coating a substrate with the dye-blended polymer, curing the dye-blended polymer, and exposing the dye-blended polymer to laser radiation. Upon exposure to the laser, the dye is altered from the first color to a second color. In one embodiment, the alteration of the dye is visible to the naked eye

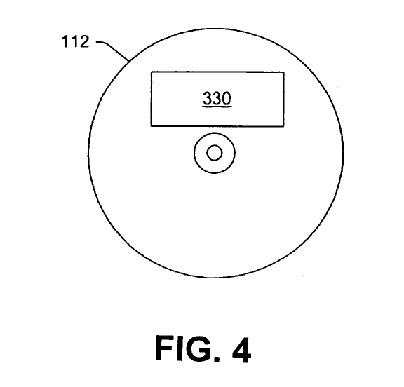

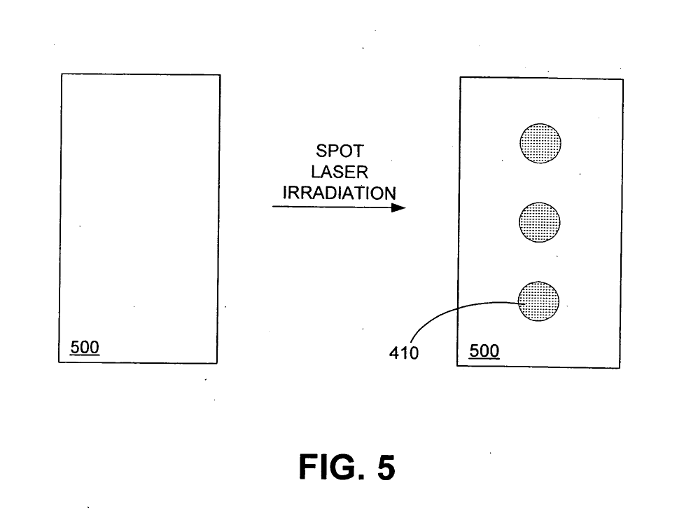

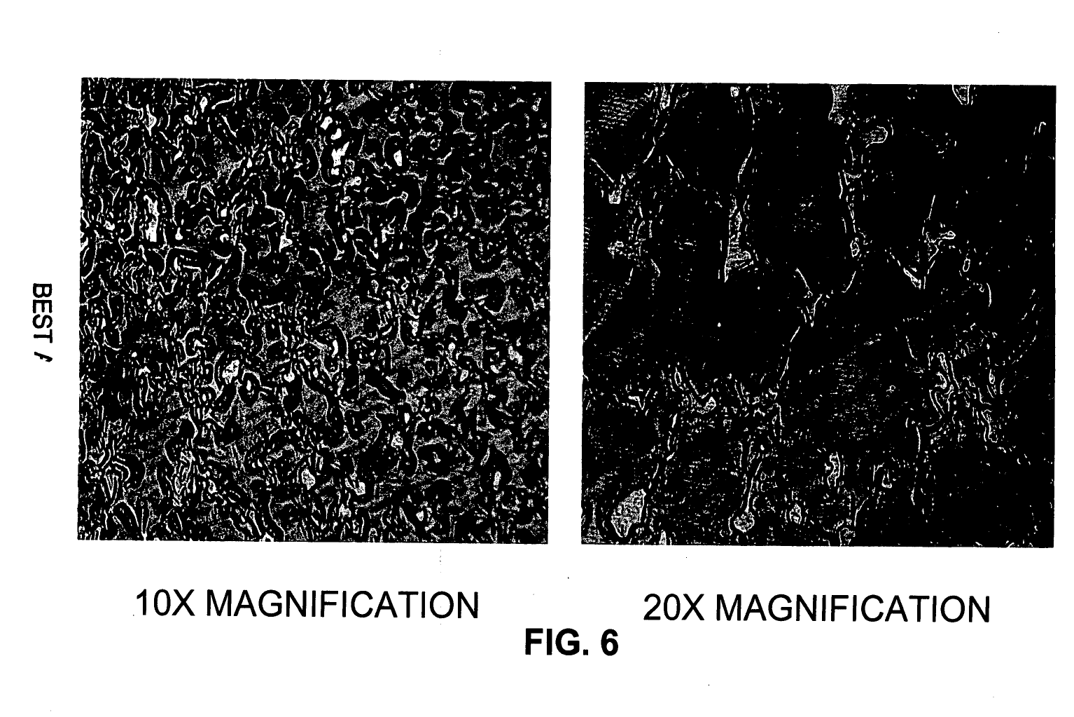

With the above exemplary methods and apparatuses in mind, FIG. 4 shows a writable label disc 112 having an exemplary laser written label 330 formed therein. FIG. 5 depicts a color change effected by a laser on a substrate 500, where the laser irradiation produces a visible change in a laser irradiated area 410. FIG. 6 shows the laser irradiated area 510 of the substrate 500 at (a) 10×magnification and (b) 20×magnification when viewed by a conventional microscope, i.e., a Nikon AFWN 10×/20 Zoom, Nikon Optizoom 0.8×-2.0×Episcopic light and view; Nikon brightdark field selector, with polarizing filters. In FIG. 6, the episcopic light source was a Fostec DCR-II and the diascopic light source was a Schott Ace I.

Also disclosed are methods of forming a color image on a laser writable substrate of a different color. When a conventional optical disc drive 104 having one write laser mechanism 108 is used to write the label, the user will be required to position the writable label disc 112 such that the laser beam will strike the writable label layer 302. Thus, for example, in certain implementations, the user would write data to the data storage portion 202 (e.g., the data storage side of the disc), then the user would flip the disc over and write to the writable label portion 300 (e.g., the labeling side). Alternatively, two separate laser mechanisms 108 can be used, one to write data to the data storage portion 202 and another disposed on the opposite side of the disc 112 to write to the writable label portion 300.

In certain implementations, logic 110 can be configured to record information on the labeling side that is about the data written on the data side. It is noted that the data written to the labeling side of the disc 112 can represent a variety of information including, for example, text, graphics, and/or images.

Many variations and modifications may be made to the above-described embodiments. All such modifications and variations are intended to be included herein within the scope of this disclosure and protected by the following claims.

The following is claimed:

1. A laser writable medium comprising:
a substrate coated on at least one side with a laser writing composition, the composition comprising
a polymer blended with a photobleachable dye with a first native color; and
wherein the polymer and dye are selected to enable a laser to visibly alter the dye from the first native color to a second photobleached color.

2. The medium of claim 1, wherein the blended polymer has a physical structure that is produced by blending the polymer and dye in a mill with inturning rollers designed to disperse solids into high viscosity liquids.

3. The medium of claim 1, wherein the polymer comprises:
an acrylate oligomer;
an acrylate monomer; and
a catalyst system.

4. The medium of claim 1, wherein the polymer comprises:
organic solvent acrylates; and
a photoinitiator.

5. The medium of claim 4, wherein the organic solvent acrylates are chosen from at least one of the following: methyl methacrylate, hexyl methacrylate, beta-phenoxy ethyl acrylate, hexamethylene acrylate, and combinations thereof.

6. The medium of claim 4, wherein the photoinitiator is a hydroxy ketone.

7. The medium of claim 1, wherein the first color is green and the second color is orange.

8. The medium of claim 1, wherein the polymer further comprises at least one of the following: a metal, a metal oxide, a photoinitiator, a pigment, and combinations thereof.

9. The medium of claim 1, wherein the dye is chosen from at least one of the following: cyanine dyes, merocyanine dyes, complex cyanine dyes, complex merocyanine dyes, holopolar cyanine dyes, styryl dyes, hemicyanine dyes, oxonole dyes, hemioxonol dyes, crystal violet, triarylmethane dyes, diarylmethane dyes, xanthene dyes, thiazine dyes, oxazine dyes, pyrylium dyes, benzopyrylium dyes, trimethinebenzopyrylium dyes, triallylcarbonium dyes, and combinations thereof.

10. A method of producing the composition of claim 1, the method comprising the step of: blending the polymer with the dye.

11. The method of claim 10, wherein the step of blending comprises
blending the polymer in a dye in a mill with inturning rollers, the mill being configured to disperse solids into a liquids.

12. A method of laser writing, comprising the steps of:
blending a curable polymer with a photobleachable dye, the dye having a first native color;
coating a substrate with the dye-blended polymer;
curing the dye-blended polymer; and
exposing the dye-blended polymer to laser radiation, whereby the dye is altered from the first color to a second color.

13. The method of claim 12, wherein the polymer comprises:
organic solvent acrylates; and
a photoinitiator.

14. The method of claim 12, wherein the photoinitiator is a hydroxy ketone.

15. The method of claim 12, wherein the dye is chosen from at least one of the following: cyanine dyes, merocyanine dyes, complex cyanine dyes, complex merocyanine dyes, holopolar cyanine dyes, styryl dyes, hemicyanine dyes, oxonole dyes, hemioxonole dyes, crystal violet, triarylmethane dyes, diarylmethane dyes, xanthene dyes, thiazine dyes, oxazine dyes, pyrylium dyes, benzopyrylium dyes, trimethinebenzopyrylium dyes, triallylcarbonium dyes, and combinations thereof.

16. The method of claim 12, wherein the dye is altered in one pass of the laser radiation over the dye.

17. The method of claim 12, wherein the laser radiation wavelength ranges from about 780 to about 790 nanometers.

18. A laser writing system comprising:
a laser; and
a substrate in proximity to the laser, wherein the substrate comprises a cured dye-blended polymer coating,
wherein the dye that is blended with the polymer is capable of being altered from a first color to a second color by the laser.

19. The laser writing system of claim 18, wherein the laser operates at one of the following wavelengths: 363-370; 370-375; 370-380; 375-380; 390-400; 410; 440-460; 460-490; 470-480; 495-515; 490-520; 520-540; 520-550; 585-595; 612-625; 618-635; 780-790; 880; and 940 nanometers.

20. The laser writing system of claim 18, wherein the substrate is a compact disc (CD).
